(19) United States
(12) Patent Application Publication
(10) Pub. No.: US 2015/0143176 A1
(43) Pub. Date: May 21, 2015

(54) IDENTIFICATION SYSTEM, IDENTIFICATION METHOD, AND PROGRAM

(71) Applicant: NEC Corporation, Tokyo (JP)

(72) Inventor: Jianwen Xiang, Tokyo (JP)

(21) Appl. No.: 14/401,686

(22) PCT Filed: May 14, 2013
(86) PCT No.: PCT/JP2013/063374

§ 371 Date: Nov. 17, 2014

(30) Foreign Application Priority Data
May 17, 2012 (JP) 2012-113652

(51) Int. Cl. G06F 11/07

(52) U.S. Cl. CPC G06F 11/079
USPC 714/37

(57) ABSTRACT

The present invention is an identification system comprising: an irrelevance trigger interpreting section for calculating a logical formula of irrelevance triggers for a component in a system from a cut set logical formula f of a system failure; and minimal cut set evaluating means for minimizing the logical formula of the irrelevance triggers, which has been calculated by said irrelevance trigger interpreting section, to calculate the irrelevance triggers for said component.

### TECHNICAL FIELD

The present invention relates to an identification system, an identification method, and a program, and particularly, to an identification system, an identification method, and a program for identifying conditions on which relevance of a component is lost in a system, where such a condition is referred to as an irrelevance trigger for a component.

### BACKGROUND ART

Fault tolerance systems are ordinarily designed to cover faults of their components with redundancy. Uncoverable faults of the components may lead to a system or subsystem failure even when adequate redundancy exists. Thus, an automatic coverage mechanism for suppressing the system or subsystem failure comprises a function of detection and isolation of a fault and a function of reconfiguration of the system. A reason thereof is as follows: in case that a failed component is not detected, switching to a spare corresponding to the failed component cannot be achieved, and in case that the failed component is not isolated, an impact may be made on other components that would otherwise be unfailed.

A model taking account of an effect of imperfect coverage is known as an imperfect coverage model (IPCM). A brief overview regarding the IPCM is provided in NPL 1.

According to the conventional IPCM, coverage is limited to failed components irrespective of relevance of the components. In brief, in case that the state of a system is not affected by coverage of a fault of a component, the component is considered to have no relevance to the system. For example, in case that a system operates in the same manner regardless of whether a component is operational or is contained in a subsystem for which a fault is covered, the component is considered to have no relevance to the system.

Even when the component has no relevance to the system, however, it is desirable to isolate/replace such a component beforehand in order to prevent a potential system failure that may result in a fault uncoverable in the future caused by the component.

In many studies of the IPCM, a system is generally considered to be originally a coherent system, that is, all components have relevance in an initial state of the system.

However, an initially relevant component may possibly become irrelevant under some specific condition thereafter. Such a specific condition will be referred to hereinbelow as an irrelevance trigger for a component. Generally, an irrelevance trigger is a fault of another component. From this point of view, even for an originally coherent system, it is important to identify and isolate components irrelevant to the system during operation and maintenance.

Conventional methods, however, cannot address a problem of finding under what conditions an originally relevant component becomes an irrelevant component, that is, cannot derive what kind of factors serve as irrelevance triggers for the component.

Identification of an irrelevant component in a specific system state and identification of irrelevance triggers for a component are different from each other. An irrelevance trigger for a component is state-independent, and plays an important role in system reliability analysis. More particularly, a fault of a component occurring before occurrence of an irrelevance trigger for the component and a fault of a component occurring after occurrence of an irrelevance trigger for the component should be distinguished from each other.

The former may lead to a system or subsystem failure unless the fault is covered. On the other hand, the latter has no effect on the system when the component has been already isolated before the irrelevance trigger occurs because the component is nothing to do with coverage of the fault. It is thus desirable to cover irrelevant components in a system; besides, it is impossible to precisely analyze reliability of the system without knowing irrelevance triggers for every component (closed-form solution).

One method of identifying irrelevance triggers for a component involves performing 100-percent testing on irrelevance for all components in every system state. In case that no relevance for a component is found in a certain system state, the state can be regarded as an irrelevance trigger for the component.

This method, however, is exponentially complicated, and hence, is impractical. Assuming, for example, that there are n components and each component has two states (for example, operational or failed), there may be 2ⁿ system states.

Moreover, by limiting coverage of irrelevant components to several important components, coverage may be more efficiently achieved than the 100-percent testing for every system state, by observing occurrence of irrelevance triggers for the important components.

Further, analogues of the irrelevance trigger are disclosed in NPLs 2 and 3.

The factors in these models, however, need to be manually specified by a modeler. The manual specification of these factors is subject to errors, and especially, is impossible in case that the structure of a system failure is not simple. Therefore, an automatic approach to identification of irrelevance triggers would be beneficial and is needed.

### CITATION LIST

### Non Patent Literature

NPL 1: S. V. Amari, A. F. Myers, A. Rauzy, and K. S. Trivedi, “Handbook of Performability Engineering,” Chapter 22: Imperfect coverage models: Status and trends, Springer, pp. 321-348, 2008.
NPL 2: J. B. Dugan, S. Bavuso, and M. Boyd, “Dynamic fault tree models for fault tolerant computer systems,” IEEE Transactions on Reliability, 1992, Vol. 41, No. 3, pp. 363-377.
NPL 3: Marc Bouissou and Jean-Louis Bon, “A new formalism that combines advantages of fault trees and Markov models: Boolean logic driven Markov processes,” Reliability Engineering and System Safety, Elsevier, 2003, Vol. 82, pp. 149-163.

### SUMMARY OF INVENTION

### Technical Problem

According to the technique described in NPL 2 or 3, irrelevance triggers need to be manually specified.

Thus, the present invention is directed to provision of an identification system, an identification method, and a program capable of identifying irrelevance triggers in a system even in case that they are not manually specified.

### DISCLOSURE OF THE INVENTION

The present invention is an identification system comprising: an irrelevance trigger interpreting section for calculating a logical formula of irrelevance triggers for a component in a system from a cut set logical formula f of a system failure; and minimal cut set evaluating means for minimizing the logical formula of the irrelevance triggers, which has been calculated by said irrelevance trigger interpreting section, to calculate the irrelevance triggers for said component.

The present invention is an identification method wherein: an information processing apparatus calculates a logical formula of irrelevance triggers for a component in a system from a cut set logical formula f of a system failure; and the information processing apparatus minimizes said calculated logical formula of the irrelevance triggers to calculate the irrelevance triggers for said component.

The present invention is a program for causing a computer to execute the processing of: calculating a logical formula of irrelevance triggers for a component from a cut set logical formula f of a system failure; and minimizing said calculated logical formula of the irrelevance triggers to calculate the irrelevance triggers for said component.

### Advantageous Effects of Invention

The present invention is capable of identifying irrelevance triggers for a component in a system even in case that they are not manually specified.

### BRIEF DESCRIPTION OF DRAWINGS

FIG. 1 is a block diagram showing a configuration of an embodiment of the present invention.

FIG. 2 is a flow chart showing an operation of the embodiment of the present invention.

### DESCRIPTION OF EMBODIMENTS

An embodiment of the present invention will be described.

First, logical definitions of terminology used in the present embodiment will be described hereinbelow.

Definition 1: (Irrelevant Variable) Let f be a Boolean formula and x be a variable of f, then x is irrelevant in f if and only if f(1/x)=f(0/x).

Definition 2: (Coherence Formula) When a Boolean formula is monotonic and relevance is found for all variables, the Boolean formula is coherent.

Definition 3: (Irrelevance trigger) Let f be a coherent formula and x be a variable of f, a product τ is an irrelevancy trigger of x if and only if

x∉τ

and

f(1/τ,1/x)=f(1/τ,0/x)_{.}

Definition 4: (Minimal irrelevance trigger) Let f be a coherent formula and x be a variable of f, an irrelevancy trigger τ of x is minimal if and only if no other trigger τ′ of x such that

τ′⊂τ.

Definition 5: (Cut set) Let f be a monotonic formula and a be a product (of variables), α is a cut set if

α|=f.

Definition 6: (Minimal cut set) Let f be a monotonic formula and α be a cut set of f, α is minimal if and only if no other cut set β of f such that

β⊂α.

Following the definitions provided above, according to the present embodiment, a failure logic formula for a system is generally handled as a Boolean formula that is coherent in the beginning, and a fault of a component to be covered is considered to be a variable of the failure logic formula for the system.

Now let “\” stands for a set difference operator. Then, when applying a set operation, a logical product and a disjunctive normal form (DNF) represent one set of variables and one set of sets of variables, respectively. Let us define min as a formula that removes redundant logical products from a set of logical products (DNF) based on Boolean algebra. Then, based on Definitions 1 through 6 provided above, a formula for calculating minimal irrelevance triggers for a certain variable in a coherent formula is derived as given below (Theorem 1).

Theorem 1: (Calculation of minimal irrelevance triggers)

Let f be a coherent formula and x be a variable of f.

Let

f=A [symbol] B,

where A and B are disjunctive normal forms (DNFs) whose conjunctive clauses are the (minimal) cut sets of f with and without x, respectively, then all the minimal irrelevancy triggers of x can be calculated as min(T), where

T= [symbol] _{α∈A}( [symbol] _{β∈B}(β\α)).

Next, an embodiment of an irrelevance trigger identification system using the formula in Theorem 1 provided above will be described in detail with reference to the drawing.

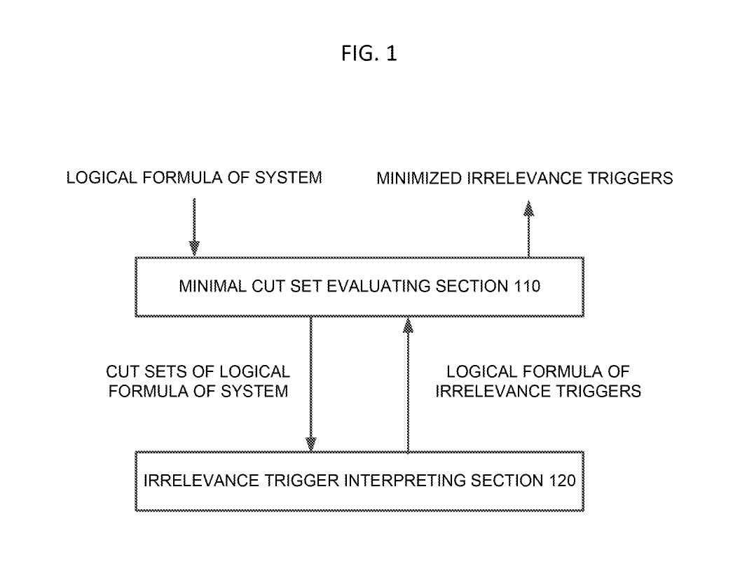

Referring to FIG. 1, the embodiment of the present invention comprises a minimal cut set evaluating section 110 and an irrelevance trigger interpreting section 120.

The minimal cut set evaluating section 110 is for calculating (minimal) cut sets of a fault tree (or a model representing a logic of a system failure). Although the aforementioned cut sets are not necessarily minimal, it is preferable to minimize them so as to reduce the complexity of the next process and the processing of minimization of factors. The section 110 also minimizes a logical formula of irrelevance triggers for a component generated by the irrelevance trigger interpreting section 120. This is because the logical formula of irrelevance triggers is defined as a logical product similarly to the definition of a cut set, and reduction rules and algorithms for minimizing cut sets may be applied for minimizing the logical formula of irrelevance triggers as well.

The irrelevance trigger interpreting section 120 is for classifying (minimal) cut sets from a point of view of the component, and calculating irrelevance triggers for a certain component (variable) based on the classified (minimal) cut sets. The irrelevance trigger interpreting section 120 is supplied with a component (variable) for which irrelevance triggers are to be calculated. The irrelevance trigger interpreting section 120 classifies cut sets from the minimal cut set evaluating section 110 into two groups according to whether or not the component is included. The irrelevance trigger interpreting section 120 then applies Theorem 1 provided earlier to the (minimal) cut sets classified into two groups, and calculates a logical formula that logically encompasses all of the irrelevance triggers for the component. It should be noted that the structure of the calculated irrelevance triggers is not necessarily minimal, and the irrelevance triggers may be minimized by inputting the calculated logical formula to the minimal cut set evaluating section 110 again.

Next, an operation of the configuration provided above will be described.

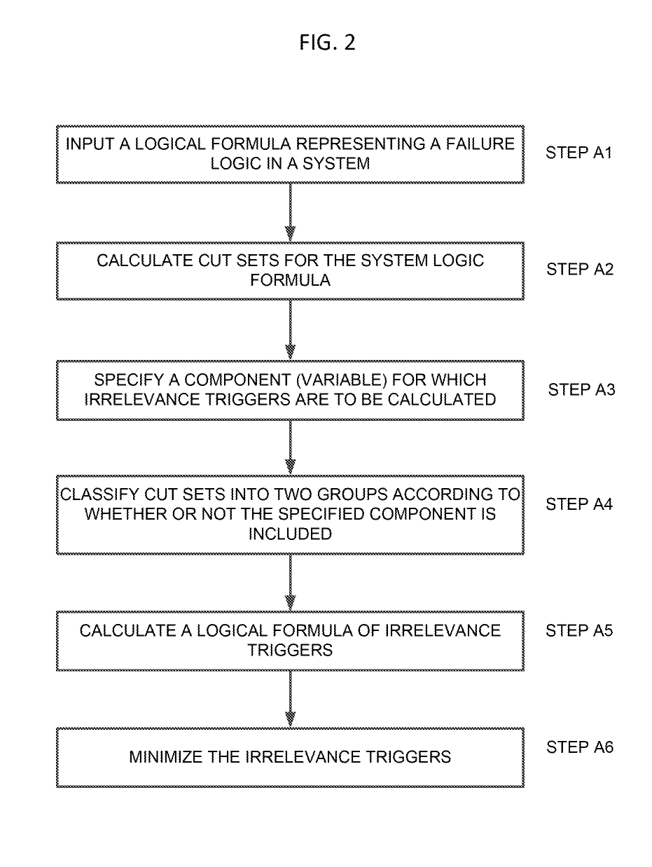

An operation of the system shown in FIG. 1 will be described with reference to the flow chart in FIG. 2.

First, a logical formula representing a failure logic in a system is input to the minimal cut set evaluating section 110 (Step A1). The logical formula of the failure logic is comprised of faults of components that cause a system failure. The logical formula of the failure logic may be represented by a fault tree or another combinatorial model. The logical formula of the failure logic is initially coherent, and all components have relevance in an initial stage.

The minimal cut set evaluating section 110 calculates cut sets for the input logical formula (Step A2). The calculation may be achieved by an existing algorithm for minimal cut sets, for example, a method based on a conventional top-down method of construction of a binary decision graph (BDD).

Next, for the irrelevance trigger interpreting section 120, a component (variable) for which irrelevance triggers are to be calculated is specified (Step A3). Then, the irrelevance trigger interpreting section 120 classifies the cut sets from the minimal cut set evaluating section 110 into two groups according to whether or not the specified component is included (Step A4).

Subsequently, the irrelevance trigger interpreting section 120 applies Theorem 1 to the (minimal) cut sets classified into two groups to calculate irrelevance triggers as a logical formula (Step A5).

Since the irrelevance triggers calculated as a logical formula are in a logical product like cut sets, the minimal cut set evaluating section 110 minimizes the irrelevance triggers represented by a logical formula by applying the aforementioned method or algorithm based on the conventional top-down method of construction of a binary decision graph (BDD) (Step A6).

According to the present embodiment, given a failure logic formula representing a failure logic in a system, irrelevance triggers for components in the system can be identified.

### Exemplary Embodiment 1

A specific exemplary embodiment of the present invention will be described.

In the present exemplary embodiment, it is assumed that a system is comprised of eight components, and a failure logic in the system is represented by the following logical formula:

f=x₁ [symbol] x₂\textcircled{}(x₃\textcircled{}x₄ [symbol] x₅\textcircled{}x₆) [symbol] x₂\textcircled{}(x₄ [symbol] x₇ [symbol] x₅\textcircled{}x₈),

where

xᵢ(i∈1 . . . 8)

stands for a covered fault of a component xᵢ. It should be noted that in the following description, the same symbol xᵢ is employed to represent a component and a covered fault of the component for the sake of a better understanding. According to the failure logic, the system is initially a coherent system, that is, all components have relevance.

Now a description will be given of an example in which a component x₁ is an important component and a component losing relevance should be isolated, and here is identified under what kind of conditions the component x₁ becomes irrelevant (loses its relevance), that is, what minimal irrelevance triggers for the component x₁ are.

To identify minimal irrelevance triggers for the component x₁, first, the logical formula f of a failure logic in the system is input to the minimal cut set evaluating section 110 (Step A1). Then, the minimal cut set evaluating section 110 calculates minimal cut sets for the logical formula f (Step A2). A set of four calculated minimal cut sets of the logical formula f is thus represented by the following equation:

min(f)={{x₁,x₂,x₃,x₄},{x₁,x₂,x₅,x₆},{x₂,x₄,x₇},{x₂,x₅,x₈}}.

To analyze minimal irrelevance triggers for the variable (component) x₁, x₁ is supplied to the irrelevance trigger interpreting section 120 as a target variable (component) (Step A3). The irrelevance trigger interpreting section 120 then classifies the minimal cut sets of the failure logic formula f into two groups A and B according to x₁ supplied is included (Step A4):

A={{x₁,x₂,x₃,x₄},{x₁,x₂,x₅,x₆}}

B={{x₂,x₄,x₇},{x₂,x₅,x₈}}.

Next, the irrelevance trigger interpreting section 120 uses Theorem 1 provided earlier to calculate a logical formula T including irrelevance triggers for the component x₁ as given below (Step A5):

$$\begin{matrix}T = ( {b}_{1} \backslash {a}_{1} {b}_{2} \backslash {a}_{1} ) ( {b}_{1} \backslash {a}_{2} {b}_{2} \backslash {a}_{2} ) \\ = ( \{ {x}_{2} , {x}_{4} , {x}_{7} \} \backslash \{ {x}_{1} , {x}_{2} , {x}_{3} , {x}_{4} \} \{ {x}_{2} , {x}_{5} , {x}_{8} \} \backslash \{ {x}_{1} , {x}_{2} , {x}_{3} , {x}_{4} \} ) \\ ( \{ {x}_{2} , {x}_{4} , {x}_{7} \} \backslash \{ {x}_{1} , {x}_{2} , {x}_{5} , {x}_{6} \} \{ {x}_{2} , {x}_{5} , {x}_{8} \} \backslash \{ {x}_{1} , {x}_{2} , {x}_{5} , {x}_{6} \} ) \\ = ( {x}_{7} {x}_{5} {x}_{8} ) ( {x}_{4} {x}_{7} {x}_{8} )\end{matrix}$$

where a₁ denotes {x₁, x₂, x₃, x₄} in A, a₂ denotes {x₁, x₂, x₅, x₆} in A, b₁ denotes {x₂, x₄, x₇} in B, and b₂ denotes {x₂, x₅, x₈} in B.

The logical formula of the irrelevance triggers for the component x₁, that is, T, calculated by the irrelevance trigger interpreting section 120 is input to the minimal cut set evaluating section 110. The minimal cut set evaluating section 110 then finds minimal irrelevance triggers for the component x₁, that is, performs minimization of T (Step A6). This is because in T, the irrelevance triggers are defined as a logical product similarly to the definition of a cut set, and reduction rules and algorithms for minimizing cut sets may be applied for minimizing the logical formula of irrelevance triggers as well. In the present example, minimal irrelevance triggers for the component x₁ may be represented by the following equation:

$$\begin{matrix}min ( T ) = min ( {x}_{7} {x}_{4} {x}_{7} {x}_{8} {x}_{4} {x}_{5} {x}_{7} {x}_{8} {x}_{5} {x}_{8} ) \\ = \{ \{ {x}_{4} , {x}_{7} \} , \{ {x}_{7} , {x}_{8} \} , \{ {x}_{5} , {x}_{8} \} \} .\end{matrix}$$

According to the equation provided above, when any of the three minimal irrelevance triggers ({x₄, x₇}, {x₇, x₈}, {x₅, x₈}) occurs, the component x₁ becomes irrelevant to the system and should be isolated. For example, a pair of components x₄ and x₇, which is an irrelevance trigger, experiences faults, the component x₁ becomes a component having no relevance following Definition 3, which is represented by the following equation:

$$\begin{matrix}f ( 1 / \{ {x}_{4} , {x}_{7} \} , 1 / {x}_{1} ) = {x}_{2} {x}_{3} {x}_{2} {x}_{5} {x}_{6} {x}_{2} \\ = {x}_{2} \\ = f ( 1 / \{ {x}_{4} , {x}_{7} \} , 0 / {x}_{1} ) ,\end{matrix}$$

so that the logical product of {x₄, x₇} is an irrelevance trigger of x₁.

Likewise, when a pair of components x₇ and x₈, which is an irrelevance trigger, experiences faults, the component x₁ becomes a component having no relevance following Definition 3. When a pair of components x₅ and x₈, which is an irrelevance trigger, experiences faults, the component x₁ becomes a component having no relevance following Definition 3. That is, the logical product of {x₇, x₈} and logical product of {x₅, x₈} are irrelevance triggers of the component x₁.

As described above, by identification of irrelevance triggers for a component executed by the minimal cut set evaluating section 110 and irrelevance trigger interpreting section 120, the present invention eliminates the need to manually specify irrelevance triggers of a system, and can identify irrelevance triggers for components in the system. Thus, during maintenance, in a system having imperfect coverage, components having no relevance to a failure of the system can be covered in a timely manner to improve system reliability.

Now this is the end of the explanation As of the embodiment and exemplary embodiment of the present invention, wherein several parts may be configured in hardware, and they also may be implemented by a computer program, as is obvious from the preceding description. In this case, a processor that is operated by programs stored in a program memory implements functions and/or operations similar to those in the embodiment described above. Moreover, only part of functions of the embodiment described above may be implemented by a computer program.

Moreover, part or all of the preceding embodiment may be described as in the following appendices, although not limited thereto.

(Supplementary note 1) An identification system comprising:

an irrelevance trigger interpreting section for calculating a logical formula of irrelevance triggers for a component in a system from a cut set logical formula f of a system failure; and

minimal cut set evaluating means for minimizing the logical formula of the irrelevance triggers, which was calculated by said irrelevance trigger interpreting section, to calculate the irrelevance triggers for said component.

(Supplementary note 2) The identification system as recited in Supplementary note 1, wherein:

said irrelevance trigger interpreting section classifies the cut set logical formula f of a system failure into A and B according to whether or not a variable corresponding to the component for which irrelevance triggers are to be identified is included to obtain

f=A [symbol] B,

and calculates the logical formula of the irrelevance triggers for said component for which the irrelevance triggers are to be identified based on

T= [symbol] _{α∈A}( [symbol] _{β∈B}(β\α))

(where α and β denote cut sets).

(Supplementary note 3) The identification system as recited in Supplementary note 1 or 2, wherein:

said minimal cut set evaluating means is used to calculate and minimize cut sets from said logical formula of a system failure.

(Supplementary note 4) An identification method wherein:

an information processing apparatus calculates a logical formula of irrelevance triggers for a component in a system from a cut set logical formula f of a system failure; and

the information processing apparatus minimizes said calculated logical formula of the irrelevance triggers to calculate the irrelevance triggers for said component.

(Supplementary note 5) The identification method as recited in Supplementary note 4, wherein:

the information processing apparatus classifies the cut set logical formula f of a system failure into A and B according to whether or not a variable corresponding to the component for which irrelevance triggers are to be identified is included to obtain

f=A [symbol] B,

and calculates the logical formula of the irrelevance triggers for said component for which the irrelevance triggers are to be identified based on

T= [symbol] _{α∈A}( [symbol] _{β∈B}(β\α))

(where α and β denote cut sets).

(Supplementary note 6) The identification method as recited in Supplementary note 4 or 5, wherein:

the information processing apparatus performs the calculation of a logical formula of irrelevance triggers for a component after calculating and minimizing cut sets from said logical formula of a system failure by the same technique as that for the minimization of said calculated logical formula of the irrelevance triggers for said component.

(Supplementary note 7) A program for causing a computer to execute the processing of:

calculating a logical formula of irrelevance triggers for a component from a cut set logical formula f of a system failure; and

minimizing said calculated logical formula of the irrelevance triggers to calculate the irrelevance triggers for said component.

(Supplementary note 8) The program as recited in Supplementary note 7, wherein:

said processing of calculating a logical formula of irrelevance triggers for a component classifies the cut set logical formula f of a system failure into A and B according to whether or not a variable corresponding to the component for which irrelevance triggers are to be identified is included to obtain

f=A [symbol] B,

and calculates the logical formula of the irrelevance triggers for said component for which the irrelevance triggers are to be identified based on

T= [symbol] _{α∈A}( [symbol] _{β∈B}(β\α))

(where α and β denote cut sets).

(Supplementary note 9) The program as recited in Supplementary note 7 or 8 for causing a computer to execute the processing of:

performing the calculation of a logical formula of irrelevance triggers for a component after calculating and minimizing cut sets from said logical formula of a system failure by the same technique as that for the minimization of said calculated logical formula of the irrelevance triggers for said component.

While the present invention has been described with reference to the embodiment and exemplary embodiment, it is not necessarily limited to the embodiment and exemplary embodiment described above, and may be practiced with several modifications within a scope of the technical idea thereof. Moreover, the present invention may be practiced by combining these embodiments with one another as appropriate.

The present application claims priority based on Japanese Patent Application No. 2012-113652 filed on May 17, 2012, disclosure of which is incorporated herein in its entirety.

### REFERENCE SIGNS LIST

110 Minimal cut set evaluating section
120 Irrelevance trigger interpreting section

1. An identification system comprising:
an irrelevance trigger interpreting section configured to calculate a logical formula of irrelevance triggers for a component in a system from a cut set logical formula f of a system failure; and
minimal cut set evaluating section configured to minimize the logical formula of the irrelevance triggers, which has been calculated by said irrelevance trigger interpreting section, to calculate the irrelevance triggers for said component.

2. The identification system according to claim 1, wherein:
said irrelevance trigger interpreting section configured to classify the cut set logical formula f of a system failure into A and B according to whether or not a variable corresponding to the component for which irrelevance triggers are to be identified is included to obtain
f=A [symbol] B,
and calculate the logical formula of the irrelevance triggers for said component for which the irrelevance triggers are to be identified based on
T= [symbol] _{α∈A}( [symbol] _{β∈B}(β\α))
(where α and β denote cut sets).

3. The identification system according to claim 1, wherein:
said minimal cut set evaluating section is used to calculate and minimize cut sets from said logical formula of a system failure.

4. An identification method wherein:
an information processing apparatus calculates a logical formula of irrelevance triggers for a component in a system from a cut set logical formula f of a system failure; and
the information processing apparatus minimizes said calculated logical formula of the irrelevance triggers to calculate the irrelevance triggers for said component.

5. The identification method according to claim 4, wherein:
the information processing apparatus classifies the cut set logical formula f of a system failure into A and B according to whether or not a variable corresponding to the component for which irrelevance triggers are to be identified is included to obtain
f=A [symbol] B,
and calculates the logical formula of the irrelevance triggers for said component for which the irrelevance triggers are to be identified based on
T= [symbol] _{α∈A}( [symbol] _{β∈B}(β\α))
(where α and β denote cut sets).

6. The identification method according to claim 4, wherein:
the information processing apparatus performs the calculation of a logical formula of irrelevance triggers for a component after calculating and minimizing cut sets from said logical formula of a system failure by the same technique as that for the minimization of said calculated logical formula of the irrelevance triggers for said component.

7. A non-transitory computer readable storage medium storing a program for causing a computer to execute the processing of:
calculating a logical formula of irrelevance triggers for a component from a cut set logical formula f of a system failure; and
minimizing said calculated logical formula of the irrelevance triggers to calculate the irrelevance triggers for said component.

8. The non-transitory computer readable storage medium storing a program according to claim 7, wherein:
said processing of calculating a logical formula of irrelevance triggers for a component classifies the cut set logical formula f of a system failure into A and B according to whether or not a variable corresponding to the component for which irrelevance triggers are to be identified is included to obtain
f=A [symbol] B,
and calculates the logical formula of the irrelevance triggers for said component for which the irrelevance triggers are to be identified based on
T= [symbol] _{α∈A}( [symbol] _{β∈B}(β\α))
(where α and β denote cut sets).

9. The non-transitory computer readable storage medium storing a program according to claim 7 for causing a computer to execute the processing of:
performing the calculation of a logical formula of irrelevance triggers for a component after calculating and minimizing cut sets from said logical formula of a system failure by the same technique as that for the minimization of said calculated logical formula of the irrelevance triggers for said component.
